(19) United States
(12) Patent Application Publication
(10) Pub. No.: US 2008/0081638 A1
(43) Pub. Date: Apr. 3, 2008

(54) Method for locating a mobile unit of a distressed user

(76) Inventors: Richard Robert Boland, LaGrange, IL (US); Mark Alan McCormick, Naperville, IL (US)

Correspondence Address: Lucent Technologies Inc.;Docket Administrator, Room 3J-219, 101 Crawfords Corner Road, Holmdel, NJ, 07733-3030, US

(21) Appl. No.: 11/540,298

(22) Filed: Sep. 29, 2006

(51) Int. Cl. H04Q 7/20

(52) U.S. Cl. 455/456.1

(57) ABSTRACT

The present invention provides a method for tracking multiple mobile units based upon the initial location of a distressed mobile unit. A distressed mobile unit is one, for example, belonging to someone who has been kidnapped or had their vehicle carjacked. An MSC receives a request to locate a distressed mobile unit. The MSC determines the location of the distressed mobile unit and also other mobile units that are located in the location area. The MSC then tracks the other mobile units.

### FIELD OF THE INVENTION

The present invention relates generally to communication systems, and more particularly to a method for locating a distressed mobile unit.

### BACKGROUND OF THE INVENTION

A recent crime trend is carjacking. A carjacking occurs when a perpetrator forcibly steals a vehicle from its owner who is present at the time of the taking. The driver of the vehicle is forced out of the car, often at gunpoint. Unfortunately, there are occasions when others are in the car at the time of the carjacking. This may include children or infants of the victim of the carjacking.

Another serious crime is kidnapping. In a kidnapping situation, a person or persons are taken against their will and detained unlawfully, usually for a ransom.

In both of these cases, the victim of the crime may have in their possession a mobile unit, such as a cell phone. The mobile unit may provide tracking of the victim. However, once the perpetrators realize that the victim has a mobile unit on their person or that a mobile unit has been left in the carjacked vehicle, the perpetrator can get rid of the victim's mobile unit.

Therefore, a need exists for a method to track a distressed mobile unit. Further, a need exists for a method for tracking the mobile unit of a perpetrator who may have kidnapped or carjacked a victim, even if the perpetrator has disposed of the mobile unit of the victim.

### BRIEF SUMMARY OF THE INVENTION

A first exemplary embodiment of the present invention provides a method for tracking multiple mobile units based upon the initial location of a distressed mobile unit. A person contacts authorities about a criminal situation. The situation can be a carjacking, a kidnapping, or the like. The authorities can then initiate the tracking process as described below.

An MSC receives a request to locate a distressed mobile unit. The distressed mobile unit may be labeled as distressed due to a call from the subscriber or other person that a crime has occurred to the owner of the mobile unit. For example, the user of the distressed mobile unit may have been the victim of a carjacking, in which case the owner may have been removed from the vehicle while the owner's cell phone remained in the stolen vehicle. In an alternate exemplary embodiment, the distressed mobile unit may be located on the person of its owner, who has been kidnapped. The request may be a call to police or other authorities, or can be a call to the cellular service provider who provides service for the distressed mobile unit.

The MSC requests location information for the distressed mobile unit. The location information is preferably a set of GPS coordinates, but can alternately be a cell site, an intersection, a town, a zip code, or any other geographical representation of mobile unit 107.

The MSC determines all other mobile units currently located within the cell site where the distressed mobile unit is located.

The MSC then tracks all other mobile units currently located within the cell site that the distressed mobile unit is located. In an exemplary embodiment, the identity of all mobile units located within the cell site at the time of the location request is sent to the MSC to be passed along to authorities. The authorities can then run checks on the owners of these cell phones. This can assist the authorities in identifying any known criminals who may have been in the area of the crime at the time of the crime.

The current location of all mobile units located within the cell site where the distressed mobile unit is initially located can also be transmitted to the MSC, which would then forward them to the authorities. The location data is preferably GPS coordinates, but can alternately be a cell site, a zip code, a street address, a city name, or any other suitable geographic location.

In a second exemplary embodiment, the present invention provides a method for tracking an associated mobile unit associated with a distressed mobile unit.

The MSC receives a request to locate a distressed mobile unit. The MSC requests location information for the distressed mobile unit. The location information is preferably a set of GPS coordinates, but can alternately be a cell site, an intersection, a town, a zip code, or any other geographical representation of the distressed mobile unit.

The MSC determines all other mobile units that are currently within the same area as the distressed mobile unit. The MSC preferably determines all other mobile units that are currently located in the same cell site as the distressed mobile unit.

As the distressed mobile unit moves throughout the wireless network, it will send autonomous registration (AR) requests. An AR request is a registration message sent from a mobile unit to a base station without first receiving an explicit command from the base station. At some point if the distressed mobile unit is moving, the MSC detects an AR received from the distressed mobile unit.

Once the MSC detects the AR from the distressed mobile unit, the MSC determines if any of the other mobile units that were located within the same area as the distressed mobile unit have performed an AR request at the cell site that the distressed mobile unit has moved to.

If the two autonomous registrations occurred at the same time or near the same time, this can be an indication that the two mobile units are associated. For example, the distressed mobile unit may be located within a carjacked vehicle, while a second mobile unit may be located on the person of one of the carjackers who is currently in the vehicle. In the kidnapping scenario, the distressed mobile unit may be located on the kidnapped person while a second mobile unit is located on one of the kidnappers.

If the other mobile unit performed an autonomous registration in the same cell as the distressed mobile unit, the MSC tracks the associated mobile unit. This tracking can occur even if no more matching autonomous registrations occur with the distressed mobile unit. For example, the kidnapper or carjacker may realize that the mobile unit of the victim may be tracked, and may discard this mobile unit. In this scenario, the associated mobile unit may move to another cell site and still be tracked by the MSC. The MSC can transmit this location information relating to the associated mobile unit to the proper authorities.

### BRIEF DESCRIPTION OF THE SEVERAL VIEWS OF THE DRAWINGS

FIG. 1 depicts a communication system in accordance with an exemplary embodiment of the present invention.

FIG. 2 depicts a flowchart of a method for tracking multiple mobile units based upon the initial location of a distressed mobile unit in accordance with an exemplary embodiment of the present invention.

FIG. 3 depicts a flowchart of a method for tracking a mobile unit associated with a distressed mobile unit in accordance with an exemplary embodiment of the present invention.

### DETAILED DESCRIPTION OF THE INVENTION

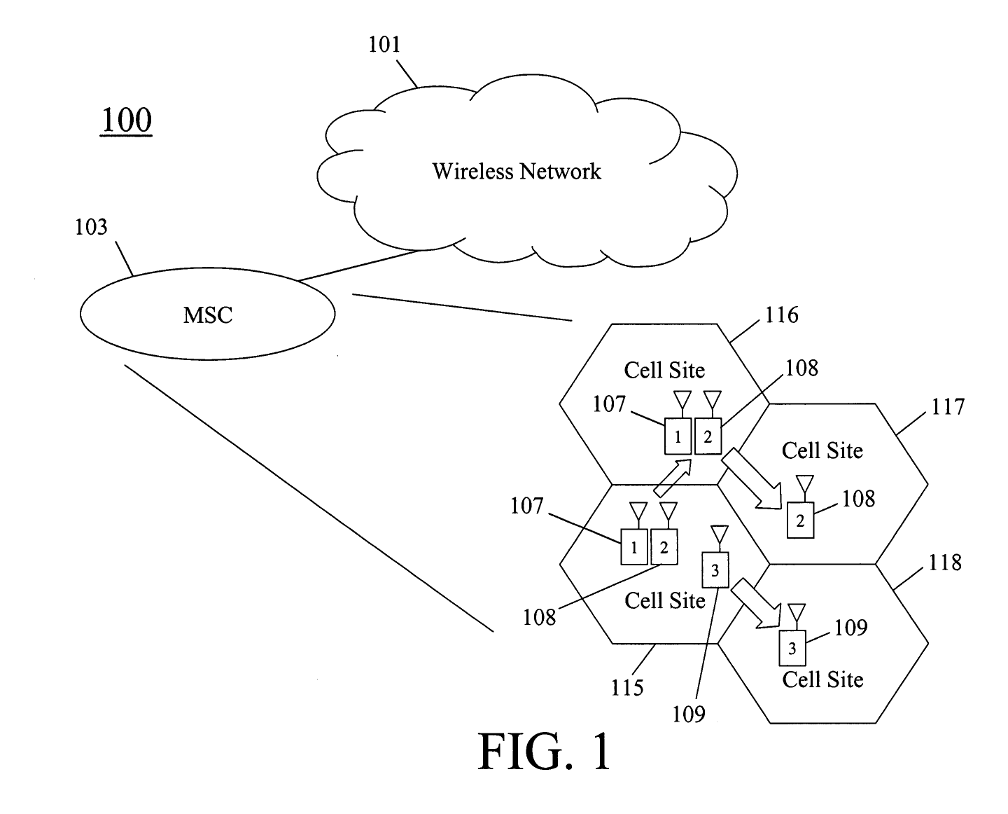

FIG. 1 depicts a communication system 100 in accordance with an exemplary embodiment of the present invention. Communication system 100 includes wireless network 101, a Mobile Switching Center (MSC) 103, and a plurality of cell sites, cell site 115, cell site 116, cell site 117, and cell site 118. Mobile units 107, 108, and 109 are in communication with communication system 100 via MSC 103.

Wireless network 101 facilitates communication within a cellular network. Wireless network 101 also allows communication with a wireline network via a Public Switched Telephone Network (PSTN). Wireless network 101 can utilize a variety of wireless protocols.

MSC 103 typically is coupled to and controls a plurality of base stations, which in turn communicate with mobile units located within their location areas. Each base station is typically responsible for a specific geographical area, commonly referred to as a cell site. MSC 103 is preferably responsible for compiling call information for billing and handing off calls from one cell to another. In an exemplary embodiment, MSC 103 is a CDMA MSC. In the exemplary embodiment depicted in FIG. 1, MSC 103 is in communication with four cell sites, cell sites 115-118, each of which would include a base station (not pictured). It should be understood that MSC 103 may control more than four cell sites, although only four cell sites are depicted in FIG. 1 for clarity.

Mobile units 107, 108, and 109 are portable units, such as a cell phones, that are registered with MSC 103. As depicted in FIG. 1, mobile units 107, 108, and 109 are all initially located within cell site 115. Mobile units 107 and 108 then move to cell site 116. Mobile unit 108 then moves to cell site 117. Mobile unit 109 moves from cell site 115 to cell site 118.

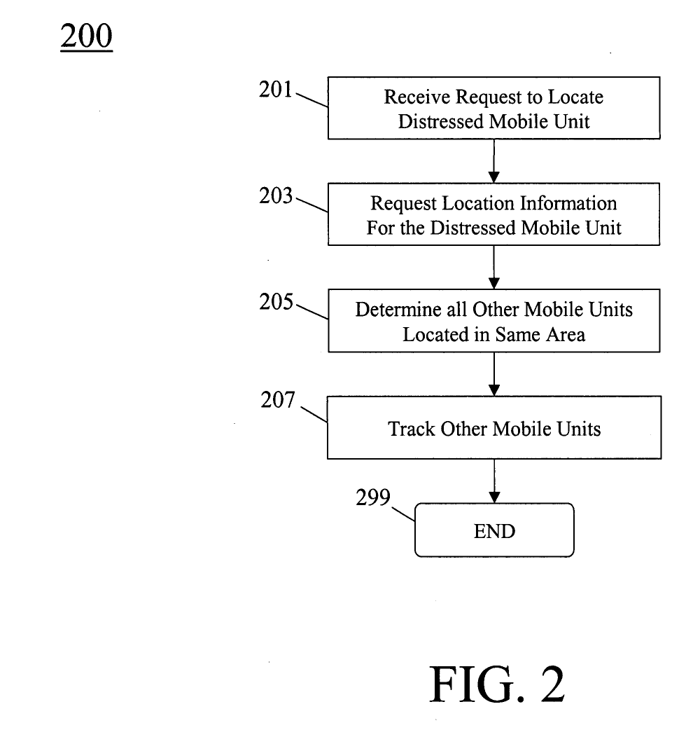

FIG. 2 depicts a flowchart 200 of a method for tracking multiple mobile units based upon the initial location of a distressed mobile unit in accordance with an exemplary embodiment of the present invention. In accordance with an exemplary embodiment, a person has contacted authorities about a criminal situation. The situation can be a carjacking, a kidnapping, or the like. The authorities can then initiate the tracking process as described below.

MSC 103 receives (201) a request to locate mobile unit 107. In this exemplary embodiment, mobile unit 107 is marked as being a distressed mobile unit. Mobile unit 107 may be labeled as distressed due to a call from the subscriber or other person that a crime has occurred to the owner of mobile unit 107. For example, the user of mobile unit 107 may have been the victim of a carjacking, in which case the owner may have been removed from the vehicle while the owner's cell phone, mobile unit 107, remained in the stolen vehicle. In an alternate exemplary embodiment, mobile unit 107 may be located on the person of its owner, who has been kidnapped. The request may be a call to police or other authorities, or can be a call to the cellular service provider who provides service for mobile unit 107.

MSC 103 requests (203) location information for mobile unit 107. The location information is preferably a set of GPS coordinates, but can alternately be a cell site, an intersection, a town, a zip code, or any other geographical representation of mobile unit 107.

MSC 103 determines (205) all other mobile units currently located within cell site 115. In the exemplary embodiment, mobile units 108 and 109 are located initially within cell site 115. This is preferably done by detecting autonomous registrations within MSC 103.

MSC 103 then tracks (207) all other mobile units currently located within cell site 115. In an exemplary embodiment, the identity of all mobile units located within cell site 115 at the time of the location request is sent to MSC 103 to be passed along to authorities. The authorities, such as the police of Federal Bureau of Investigation (FBI), can then run checks on the owners of these cell phones. This can assist the authorities in identifying any known criminals who may have been in the area of the crime at the time of the crime.

The current location of all mobile units located within cell site 115 at the time of the request can also be transmitted to MSC 103, which would then forward them to the authorities. The location data is preferably GPS coordinates, but can alternately be a cell site, a zip code, a street address, a city name, or any other suitable geographic location.

In this manner using this exemplary embodiment, the authorities are given information about all mobile units that are located within the cell site that the distressed mobile unit was located, at a time near the occurrence of the crime. The information can be cross-referenced to a felony database or the like, which would allow the authorities to identify any known felons that were in the area of the crime. Further, the continued tracking of the mobile units that were in the vicinity of the distressed mobile unit at the time of the crime allows the authorities to track down these mobile units, even as they move away from the area of the crime. This can assist the authorities in identifying and talking with any potential witnesses to the crime.

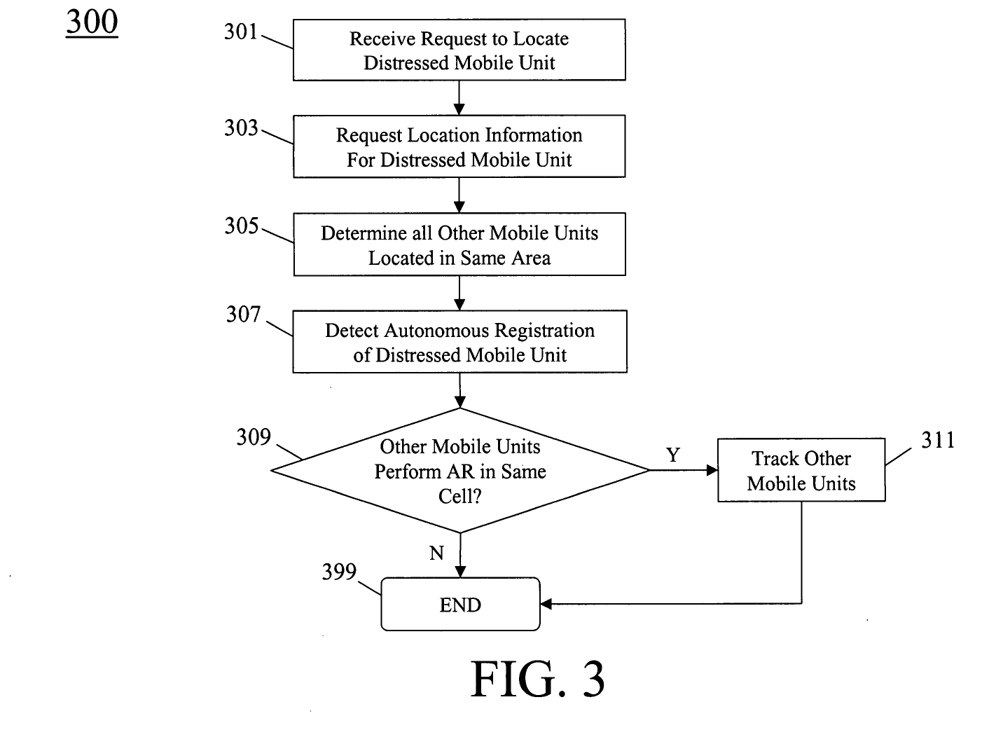

FIG. 3 depicts a flowchart 300 of a method for tracking a mobile unit associated with a distressed mobile unit in accordance with an exemplary embodiment of the present invention.

MSC 103 receives (301) a request to locate a distressed mobile unit. In accordance with an exemplary embodiment, mobile unit 107 is a distressed mobile unit. Mobile unit 107 may be labeled as distressed due to a call from the subscriber or other person that a crime has occurred to the owner of mobile unit 107. For example, the user of mobile unit 107 may have been the victim of a carjacking, in which case the owner may have been removed from the vehicle while the owner's cell phone, mobile unit 107, remained in the stolen vehicle. In an alternate exemplary embodiment, mobile unit 107 may be located on the person of its owner, who has been kidnapped.

MSC 103 requests (303) location information for distressed mobile unit 107. The location information is preferably a set of GPS coordinates, but can alternately be a cell site, an intersection, a town, a zip code, or any other geographical representation of mobile unit 107.

MSC 103 determines (305) all other mobile units that are currently within the same area as distressed mobile unit 107. In an exemplary embodiment, MSC 103 determines all other mobile units that are currently located in the same cell site as distressed mobile unit 107. In the exemplary embodiment, mobile units 108 and 109 are considered to be located in the same area as mobile unit 107, since they are both initially located within cell site 115.

As mobile unit 107 moves throughout wireless network 101, it will send autonomous registration (AR) requests. An AR request is a registration message sent from a mobile unit to a base station without first receiving an explicit command from the base station. At some point if mobile unit 107 is moving, MSC 103 detects (307) an AR received from mobile unit 107.

Once MSC 103 detects the AR from mobile unit 107, MSC 103 determines (309) if any of the other mobile units that were located within the same area as mobile unit 107 at step 305 have performed an AR request at the new cell site 116. If not, the process ends (399).

If the two autonomous registrations occurred at the same time or near the same time, this can be an indication that the two mobile units are associated. For example, first mobile unit 107 may be located within a carjacked vehicle, while second mobile unit 108 may be located on the person of one of the carjackers who is currently in the vehicle. In the kidnapping scenario, first mobile unit 107 may be located on the kidnapped person while second mobile unit 108 is located on one of the kidnappers.

If the other mobile unit performed an autonomous registration in the same cell as mobile unit 107, MSC 103 tracks (311) mobile unit 108. This tracking can occur even if no more matching autonomous registrations occur with mobile unit 107. For example, the kidnapper or carjacker may realize that the mobile unit of the victim may be tracked, and may discard this mobile unit. In this scenario, mobile unit 108 may move to cell site 117 and still be tracked by MSC 103. MSC 103 can transmit this location information relating to mobile unit 108 to the proper authorities.

This exemplary embodiment allows authorities to narrow down the pool of potential perpetrators. If the mobile unit of the victim is still either on the person of the kidnapped victim or in the carjacked car, then an association between the mobile unit of the victim and a mobile unit of one of the perpetrators can lead to great information that can allow authorities to track down the perpetrators. This exemplary embodiment even provides for continued tracking of suspected criminals in the event that they turn off the mobile unit of the victim or dispose of it, for instance by throwing it out the window of the car.

While this invention has been described in terms of certain examples thereof, it is not intended that it be limited to the above description, but rather only to the extent set forth in the claims that follow.

We claim:

1. A method for tracking multiple mobile units based upon the initial location of a distressed mobile unit, the method comprising:
receiving a request to locate a distressed mobile unit;
determining the location of the distressed mobile unit;
determining other mobile units that are located in the location; and
tracking the other mobile units.

2. A method for tracking multiple mobile units based upon the initial location of a distressed mobile unit in accordance with claim 1, wherein the step of receiving a request to locate a distressed mobile unit comprises receiving a request to locate a distressed mobile unit whose owner has been the victim of a crime.

3. A method for tracking multiple mobile units based upon the initial location of a distressed mobile unit in accordance with claim 1, wherein the distressed mobile unit is located within a stolen vehicle.

4. A method for tracking multiple mobile units based upon the initial location of a distressed mobile unit in accordance with claim 1, wherein the distressed mobile unit is located on an owner of the distressed mobile unit, and wherein the owner has been kidnapped.

5. A method for tracking multiple mobile units based upon the initial location of a distressed mobile unit in accordance with claim 1, wherein the step of determining the location of the distressed mobile unit comprises determining the GPS coordinates of the distressed mobile unit.

6. A method for tracking multiple mobile units based upon the initial location of a distressed mobile unit in accordance with claim 1, wherein the step of determining the location of the distressed mobile unit comprises determining a cell site to which the distressed mobile unit is registered.

7. A method for tracking multiple mobile units based upon the initial location of a distressed mobile unit in accordance with claim 1, wherein the step of determining the location of the distressed mobile unit comprises determining an intersection of the distressed mobile unit.

8. A method for tracking multiple mobile units based upon the initial location of a distressed mobile unit in accordance with claim 1, wherein the step of determining the location of the distressed mobile unit comprises determining a city in which the distressed mobile unit is currently located.

9. A method for tracking multiple mobile units based upon the initial location of a distressed mobile unit in accordance with claim 1, wherein the step of determining the location of the distressed mobile unit comprises determining a zip code in which the distressed mobile unit is currently located.

10. A method for tracking multiple mobile units based upon the initial location of a distressed mobile unit in accordance with claim 1, the method further comprising the step of transmitting the identity of the other mobile units to law enforcement authorities.

11. A method for tracking multiple mobile units based upon the initial location of a distressed mobile unit in accordance with claim 1, the method further comprising the step of running criminal checks on owners of each of the other mobile units that are located in the location.

12. A method for tracking a second mobile unit that is associated with a first mobile unit, comprising:
locating a first mobile unit;
identifying a second mobile unit with the first mobile unit; and
tracking the second mobile unit.

13. A method for tracking a second mobile unit that is associated with a first mobile unit in accordance with claim 12, wherein the step of locating the first mobile unit comprises determining a set of GPS coordinates associated with the current position of the first mobile unit.

14. A method for tracking a second mobile unit that is associated with a first mobile unit in accordance with claim 12, wherein the step of locating the first mobile unit comprises detecting a first autonomous registration request sent from the first mobile unit.

15. A method for tracking a second mobile unit that is associated with a first mobile unit in accordance with claim 14, wherein the step of identifying a second mobile unit with the first mobile unit comprises determining that the second mobile unit has sent a second autonomous registration request within the same area as the first mobile unit.

16. A method for tracking a second mobile unit that is associated with a first mobile unit in accordance with claim 15, wherein the step of identifying a second mobile unit with the first mobile unit comprises determining that the first autonomous registration request and the second autonomous registration request occur within a predetermined time frame.
